(19) United States
(12) Patent Application Publication
(10) Pub. No.: US 2006/0221273 A1
(43) Pub. Date: Oct. 5, 2006

(54) Diffusion plate, backlight assembly having the same and display device having the same

(75) Inventors: Ju-Hwa Ha, Seoul (KR); Jin-Sang Choi, Yongin-si (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/233,746

(22) Filed: Sep. 23, 2005

(30) Foreign Application Priority Data
Apr. 1, 2005 (KR) 10-2005-27645

(51) Int. Cl. G02F 1/1335

(52) U.S. Cl. 349/65

(57) ABSTRACT

A diffusion plate having a multi-layered structure, a backlight assembly having the diffusion plate, and a display device having the diffusion plate are presented. The diffusion plate includes a lower skin layer, a core layer, and an upper skin layer. The lower skin layer modulates and mixes light. The core layer is on the lower skin layer to diffuse the light that has passed through the lower skin layer. The upper skin layer is on the core layer. The upper skin layer has a prism patterned on a surface. Therefore, the number of optical sheets is decreased, and luminance uniformity is improved.

### CROSS-REFERENCE TO RELATED APPLICATION

This application relies for priority upon Korean Patent Application No. 2005-27645 filed on Apr. 1, 2005, the content of which is herein incorporated by reference in its entirety.

### BACKGROUND OF THE INVENTION

1. Field of the Invention

The present invention relates to a diffusion plate, a backlight assembly having the diffusion plate and a display device having the diffusion plate. More particularly, the present invention relates to a multi-layered diffusion plate, a backlight assembly having the diffusion plate and a display device having the diffusion plate.

2. Description of the Related Art

A liquid crystal display (LCD) device generally includes a backlight assembly. The backlight assembly includes a lamp assembly, a light guiding or diffusion plate assembly and a housing unit.

A backlight assembly for an LCD television receiver set further includes an optical unit. The optical unit includes a diffusion plate, a diffusion sheet on the diffusion plate, and a brightness enhancement film on the diffusion sheet. A disadvantage of using the optical unit is that when light generated from the lamp assembly passes through the optical unit having various refractive indexes, the luminance of backlight assembly is decreased. Another disadvantage of using the optical unit is that it increases the number of the optical sheets, thereby complicating the manufacturing process of the backlight assembly and increasing the manufacturing cost of the backlight assembly.

FIG. 1 is a cross-sectional view showing a light path of a backlight assembly having a diffusion plate.

Referring to FIG. 1, a diffusion plate 10 is positioned on a plurality of lamps 12 that are arranged substantially parallel to one another so that the light generated from the lamps 12 and the light reflected from the reflecting plate 14 are diffused by the diffusion plate 10.

The lamps 12 are spaced apart from one another by a predetermined pitch and form a bright line and a shadow line on the diffusion plate 10. The bright line is formed in a region “A” near the lamps 12, and the shadow line is formed in a region “B” between the lamps 12.

The thicknesses of the bright line and the shadow line vary according to the thickness and diffusibility of the diffusion plate 10. When the diffusion plate 10 is made thinner, the light transmittance of the diffusion plate 10 is increased and the luminance uniformity of the diffusion plate 10 is decreased. On the other hand, when the diffusion plate 10 is made thicker, the light transmittance of the diffusion plate 10 is decreased, and the luminance uniformity of the diffusion plate 10 is increased. In general, luminance decreases when the light is scattered.

In order to decrease the presence of the bright line and the shadow line, optical films are placed on the diffusion plate and the lamps are spaced apart from the diffusion plate. However, when the optical films are on the diffusion plate and the lamps are spaced apart from the diffusion plate, the overall thickness of the LCD device increases. Moreover, when a diffusion sheet is placed on the diffusion plate, the manufacturing cost of the LCD device increases.

When luminance is decreased, an image display quality of the LCD device is deteriorated.

A method of reducing the appearance of bright lines and shadow lines without suffering from the above disadvantages is desired.

### SUMMARY OF THE INVENTION

The present invention provides a diffusion plate having a multi-layered structure. The present invention also provides a backlight assembly having the above-mentioned diffusion plate. The present invention also provides a display device having the above-mentioned diffusion plate.

A diffusion plate in accordance with an aspect of the present invention includes a lower skin layer, a core layer and an upper skin layer. The lower skin layer modulates and mixes light. The core layer is on the lower skin layer to diffuse the light that has passed through the lower skin layer. The upper skin layer is on the core layer. The upper skin layer has a prism patterned on a surface of the upper skin layer that is farthest from the core layer.

A backlight assembly in accordance with another aspect of the present invention includes a light source unit and a diffusion plate. The light source unit generates light. The diffusion plate has a multi-layered structure including layers of varying light transmittance properties to enhance luminance uniformity of the light.

A display device in accordance with another aspect of the present invention includes a light source and a backlight assembly. The light source unit generates light. The backlight assembly includes a display panel and a luminance improving unit. The display panel is on the light source unit to display an image using the light generated from the light source. The luminance improving unit has a multi-layered structure with layers of varying light transmittance properties to increase a luminance uniformity of the light. The luminance improving unit is interposed between the light source unit and the display panel.

According to the present invention, the diffusion plate includes the multi-layered structure having layers of different light transmittance properties so that the number of the optical sheets is decreased. In addition, generation of a bright line and a shadow line from is decreased, and a luminance is increased.

### BRIEF DESCRIPTION OF THE DRAWINGS

The above and other advantages of the present invention will become readily apparent by reference to the following detailed description when considered in conjunction with the accompanying drawings wherein:

FIG. 1 is a cross-sectional view of a backlight assembly showing a light path of a backlight assembly having a diffusion plate;

FIG. 2 is a cross-sectional view of a diffusion plate in accordance with one embodiment of the present invention;

FIG. 3 is a cross-sectional view showing the optical characteristics of the diffusion plate shown in FIG. 2;

FIGS. 4A to 4G are cross-sectional views showing a method of manufacturing the diffusion plate shown in FIG. 2;

FIG. 5 is a cross-sectional view showing a method of manufacturing a diffusion plate in accordance with another embodiment of the present invention;

FIG. 6 is a cross-sectional view showing a diffusion plate in accordance with another embodiment of the present invention;

FIG. 7 is a cross-sectional view showing optical characteristics of the diffusion plate shown in FIG. 6;

FIGS. 8A to 8G are cross-sectional views showing a method of manufacturing the diffusion plate shown in FIG. 6;

FIG. 9 is a cross-sectional view showing a light path of a backlight assembly in accordance with one embodiment of the present invention;

FIG. 10 is an exploded perspective view showing a display device in accordance with one embodiment of the present invention; and

FIG. 11 is an exploded perspective view showing a display device in accordance with another embodiment of the present invention.

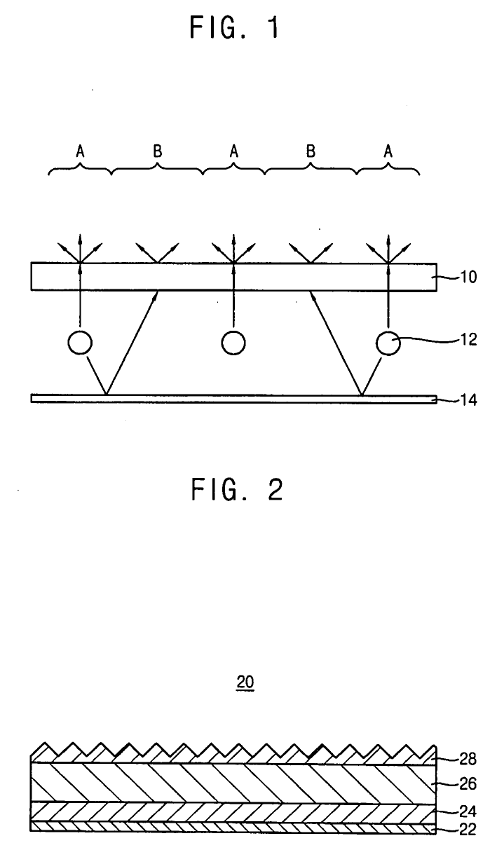

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include variations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as what is commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 2 is a cross-sectional view showing a diffusion plate in accordance with an embodiment of the present invention. In FIG. 2, an ultraviolet proof coating layer is formed under a lower skin layer.

Referring to FIG. 2, the diffusion plate 20 includes an ultraviolet proof coating layer 22, a lower skin layer 24, a core plate 26 and an upper skin layer 28. In the diffusion plate 20 in FIG. 2, a thickness of the diffusion plate 20 is about 2 mm. The diffusion plate 20 is on a lamp or a flat fluorescent lamp that generates heat and the diffusion plate 20 is heat resistant. That is, the diffusion plate 20 is not deformed from the heat from a lamp.

A thickness of the ultraviolet proof coating layer 22 is about 50 μm, and the ultraviolet proof coating layer 22 is under the lower skin layer 24. The ultraviolet proof coating layer 22 blocks an ultraviolet light. In the diffusion plate 20 in FIG. 2, light having a wavelength of no more than about 360 nm is absorbed or reflected by the ultraviolet proof coating layer 22. The absorbed light generates excitons in the ultraviolet proof coating layer 22 so that a visible light is generated from the ultraviolet proof coating layer 22.

The lower skin layer 24 modulates and mixes light beams that pass through the ultraviolet proof coating layer 22 so that the light that passes through the lower skin layer 24 evenly reaches the core plate 26.

The lower skin layer 24 has a greater refractive index than air and therefore decreases the number of bright lines and shadow lines. The bright lines and the shadow lines are formed by a flat fluorescent lamp FFL or a cold cathode fluorescent lamp CCFL. For example, the lower skin layer 24 may include a transparent material having a high refractive index. Examples of the transparent material that can be used for the lower skin layer 24 include polycarbonate (PC) based resin, polymethyl-methacrylate (PMMA) based resin, and a methacrylate-styrene copolymer (MS) resin, etc. These materials can be used individually or in combination.

The core plate 26 is on the lower skin layer 24. The core plate 26 diffuses the light that passed through the lower skin layer 24 so that the light that has passed through the core plate 26 is evenly incident on the upper skin layer 28. The core plate 26 may include a plurality of light scattering particles that scatter the light. In the diffusion plate 20 in FIG. 2, the core plate 26 has a light transmittance of no more than about 70% and a haze value of about 90%. In the diffusion plate 20 in FIG. 2, the core plate 26 has a different light transmittance property from the lower or upper skin layer 24 or 28. In some embodiments, the core plate 26, and the lower and upper skin layers 24 and 28 may have different light transmittance properties from one another.

The upper skin layer 28 has a prism patterned on a front surface thereof. The upper skin layer 28 is on the core plate 26. The upper skin layer 28 may include one or more of polycarbonate (PC) based resin, polymethyl-methacrylate (PMMA) based resin, methacrylate-styrene (MS) copolymer, polyethylene-terephthalate (PET), etc. An interior angle of the prism pattern is about 55 degrees to about 88 degrees. In the diffusion plate 20 in FIG. 2, the pitch between adjacent prisms of the prism shape is about 150 μm, and the height of the prisms is about 50 μm. The prism pattern extends in the longitudinal direction of the light source unit (not shown).

The diffusion plate 20 performs a buffering function to increase the luminance uniformity of light. In addition, the diffusion plate 20 includes the PC based resin, the PMMA based resin, etc., to function as a directional filter using Snell's law. These resins can be used alone or in combination. Furthermore, the prism pattern is optimized to increase the luminance.

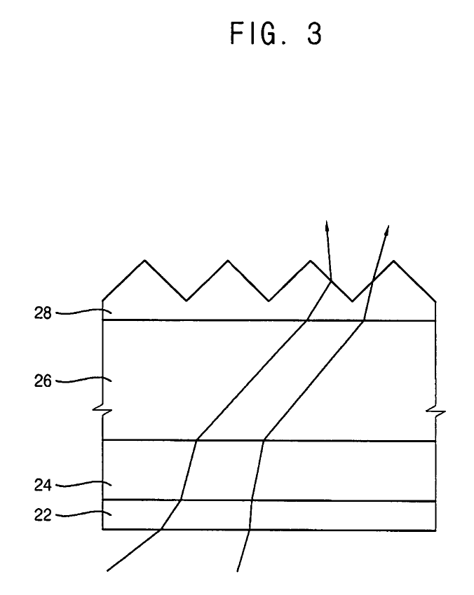

FIG. 3 is a cross-sectional view showing the optical characteristics of the diffusion plate shown in FIG. 2. In FIG. 3, the core plate 26 has a greater refractive index than the ultraviolet proof coating layer 22. Each of the lower skin layer 24 and the upper skin layer 28 has a greater refractive index than the core plate 26 and the ultraviolet proof coating layer 22. Light that is reflected from one of the core plate 26, the ultraviolet proof coating layer 22 and the lower and upper skin layers 24 and 28 is omitted in FIG. 3.

When the light is incident on a lower surface of the ultraviolet proof coating layer 22 at a predetermined incident angle, the ultraviolet proof coating layer 22 blocks the ultraviolet light in the incident light. In addition, the ultraviolet proof coating layer 22 has a greater refractive index than air, making the angle of refraction smaller than the angle of incidence for the visible light entering the ultraviolet proof coating layer 22. That is, the angle of refraction is smaller than the angle of incidence for the visible light at an interface between the air and the ultraviolet proof coating layer 22.

The light that passes through the ultraviolet proof coating layer 22 is refracted by the lower skin layer 24 so that the light that has passes through the lower skin layer 24 is incident on the core plate 26. The lower skin layer 24 has a greater refractive index than the ultraviolet proof coating layer 22, making the angle of refraction smaller than the angle of incidence at the interface between the ultraviolet proof coating layer 22 and the lower skin layer 24.

The light that is incident on the core plate 26 is refracted by the core plate 26 so that the refracted light is incident into the upper skin layer 28. The core plate 26 has a smaller refractive index than the lower skin layer 24 so that the angle of refraction is greater than the angle of incidence at the interface between the lower skin layer 24 and the core plate 26.

The light that is incident on the upper skin layer 28 is refracted by the upper skin layer 28 so that the refracted light exits the upper skin layer 28 as shown by the arrows in FIG. 3. The upper skin layer 28 has a greater refractive index than the core plate 26 so that the angle of refraction is smaller than the angle of incidence at the interface between the core plate 26 and the upper skin layer 28. When the light beam leaves the upper skin layer 28, the angle of refraction is smaller than the angle of incidence at the interface between the upper skin layer 28 and air.

As the lower and upper skin layers 24 and 28 that have a transparent material of high light transmittance are on both sides of the core plate 26, the lower skin layer 24, the core plate 26 and the upper skin layer 28 may be formed through a plurality of extrusion parts. In the diffusion plate 30 in FIG. 2, the diffusion plate 20 is manufactured by a system for manufacturing the diffusion plate having a first extrusion part, a second extrusion part and a third extrusion part. The first extrusion part extrudes the core plate 26. The second extrusion part extrudes the lower skin layer 24, and attaches the lower skin layer 24 to the lower surface of the core plate 26. The third extrusion part extrudes the upper skin layer 28 and attaches the upper skin layer 28 to the upper surface of the core plate 26.

A plurality of prisms is formed on the upper skin layer 28 through a hot press process or a casting process.

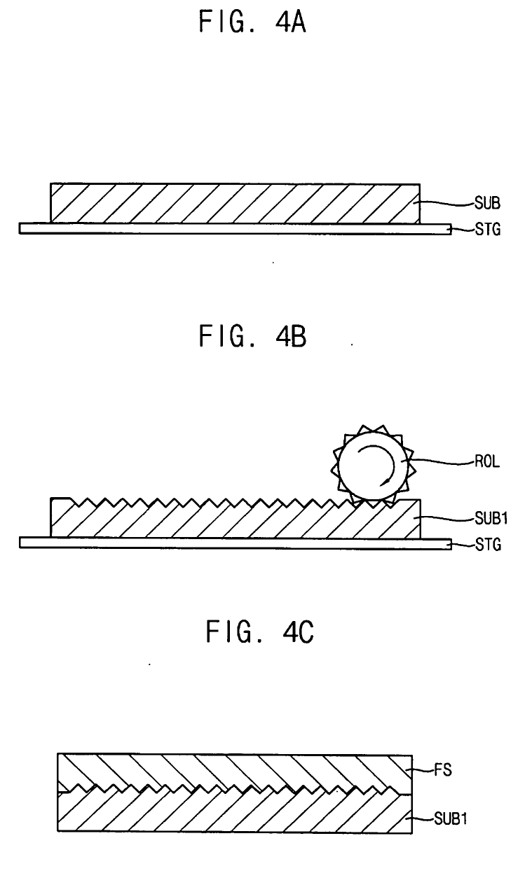

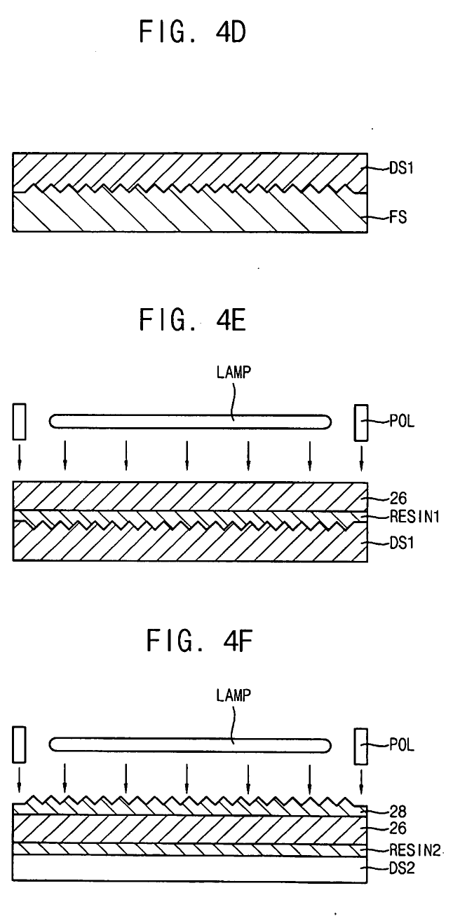

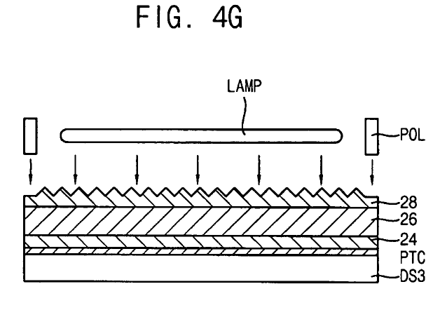

FIGS. 4A to 4G are cross-sectional views showing a method of manufacturing the diffusion plate shown in FIG. 2.

Referring to FIG. 4A, a base substrate SUB is prepared on a stage STG. A metal is deposited on the base substrate SUB to a thickness of about 1 mm. Examples of the metal that can be used for the deposition include copper, brass, aluminum, nickel, etc. A surface of the base substrate SUB is polished by a flat diamond polisher (not shown).

Referring to FIG. 4B, a plurality of recesses that have substantially the same depth is formed on the base substrate SUB using a roller ROL having a plurality of protrusions. Alternatively, the recesses may be formed using a diamond bite (not shown). An interior angle of each of the recesses is about 55 degrees to about 88 degrees. The pitch between adjacent recesses is about 150 μm.

Referring to FIG. 4C, a father stamper FS is formed by a casting process using the base substrate SUB. In the casting process, molten metal is deposited on a base substrate SUB1 having the recesses, and then cooled to be solidified. The father stamper FS has a pattern that is the reverse of the recesses of the base substrate SUB1.

Referring to FIG. 4D, a first daughter stamper DS1 is formed by a casting process using the father stamper FS. In the casting process for forming the first daughter stamper DS1, molten metal is deposited on the father stamper FS, and then cooled to be solidified. The first daughter stamper DS1 has a pattern that is the reverse of the surface of the father stamper FS, and the first daughter stamper DS1 has substantially same cross-section as the base substrate SUB1. A plurality of daughter stampers such as a second daughter stamper, a third daughter stamper, etc., may be formed through the casting process.

The diffusion plate 20 is manufactured using a plurality of stampers. The stampers may be formed from one base substrate. In FIG. 4D, a plurality of daughter stampers is formed using the father stamper FS to prevent an abrasion of the base substrate.

In FIG. 4D, the father stamper FS has substantially the same cross-section as the diffusion plate 20, and the base substrate SUB has substantially the same cross-section as the first daughter stamper DS1. That is, the father stamper FS has a pattern that is the reverse of the pattern on the diffusion plate 20.

Referring to FIG. 4E, a first ultraviolet curable resin RESIN1 is coated on the recesses of the first daughter stamper DS1, and a core plate 26 is prepared on the first ultraviolet curable resin RESIN1. A peripheral region of the core plate 26 is pressed by a side compressor POL, and ultraviolet light is irradiated onto the first ultraviolet curable resin RESIN1 so that the first ultraviolet curable resin RESIN1 is attached to the core plate 26. The first daughter stamper DS1 is then removed from the first ultraviolet curable resin RESIN1. Therefore, the upper skin layer 28 that is formed from the first ultraviolet curable resin RESIN1 is completed.

Referring to FIG. 4F, a second ultraviolet curable resin RESIN2 is coated on the recesses of a second daughter stamper DS2, and the core plate 26 having the first ultraviolet curable resin RESIN1 is prepared on the second ultraviolet curable resin RESIN2 so that the second ultraviolet curable resin RESIN2 is on the opposite surface of the core plate 26 from the first ultraviolet curable resin RESIN1. A peripheral region of the core plate 26 is pressed by the side compressor POL, and ultraviolet light is irradiated onto the second ultraviolet curable resin RESIN2 so that the second ultraviolet curable resin RESIN2 is attached to the core plate 26. The second daughter stamper DS2 is then removed from the second ultraviolet curable resin RESIN2. Therefore, the lower skin layer 24 that is formed from the second ultraviolet resin RESIN2 is completed.

Referring to FIG. 4G, an ultraviolet proof material PTC is coated on recesses of a third daughter stamper DS3, and the core plate 26 having the first and second ultraviolet curable resins RESIN1 and RESIN2 is prepared on the ultraviolet proof material PTC so that the ultraviolet proof material PTC makes contact with the second ultraviolet curable resin RESIN2. A peripheral region of the core plate 26 is pressed by the side compressor POL, and an ultraviolet light that is generated from a lamp LAMP is irradiated onto the ultraviolet proof material PTC so that the ultraviolet proof material PTC is attached to the second ultraviolet curable resin RESIN2. Therefore, the diffusion plate 20 shown in FIG. 2 that is formed from the ultraviolet proof material PTC is completed.

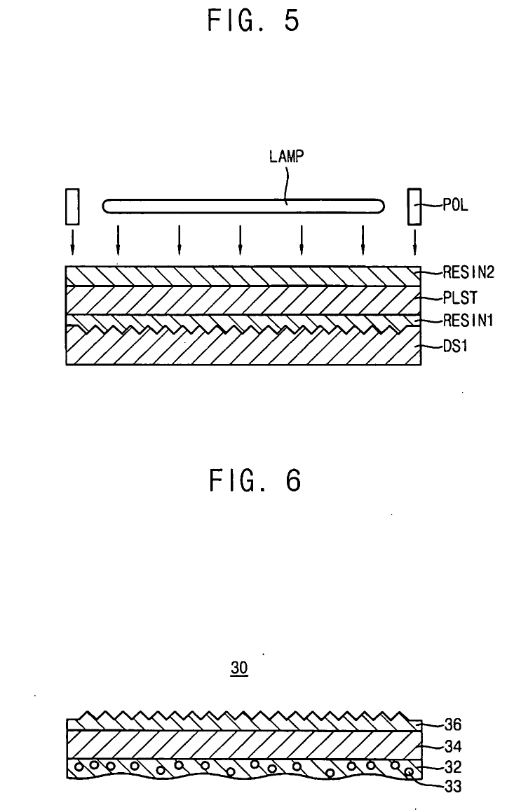

FIG. 5 is a cross-sectional view showing a method of manufacturing a diffusion plate in accordance with another embodiment of the present invention. The method of manufacturing the diffusion plate of FIG. 5 is the same as in FIGS. 2 and 4A to 4F except for a daughter stamper. Thus, the same reference numerals will be used to refer to the same or like parts as those described in FIGS. 2 and 4A to 4F and any further explanation concerning the above elements will be omitted.

Referring to FIG. 5, a first ultraviolet curable resin RESIN1 and a second ultraviolet curable resin RESIN2 are coated on recesses of a first daughter stamper DS1 and an upper surface of the core plate PLST, respectively, and the first ultraviolet curable resin RESIN1 is combined with a lower surface of the core plate PLST. A peripheral region of the second ultraviolet curable resin RESIN2 is pressed by a side compressor POL, and an ultraviolet light that is generated from the lamp LAMP is irradiated onto the first and second ultraviolet curable resins RESIN1 and RESIN2 so that the first and second ultraviolet curable resins RESIN1 and RESIN2 are attached to the lower and upper surfaces of the core plate PLST.

Therefore, the diffusion plate 20 having the lower skin layer 24 and the ultraviolet proof coating layer 22 shown in FIG. 2 is completed.

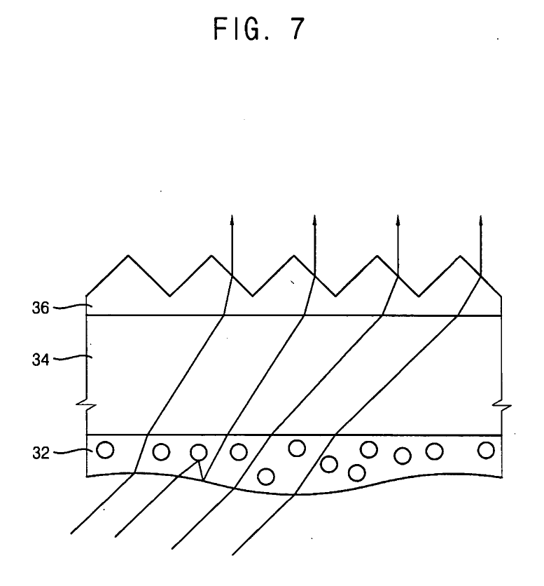

FIG. 6 is a cross-sectional view showing a diffusion plate in accordance with another embodiment of the present invention. The diffusion plate in FIG. 6 is the same as in FIGS. 2 and 3 except ultraviolet proof particles. Thus, the same reference numerals will be used to refer to the same or like parts as those described in FIGS. 2 and 3 and any further explanation concerning the above elements will be omitted.

Referring to FIG. 6, the diffusion plate 30 includes a lower skin layer 32, a core plate 34 and an upper skin layer 36. In the diffusion plate 30 in FIG. 6, a thickness of the diffusion plate 30 is about 2 mm. The diffusion plate 30 is on a lamp or a flat fluorescent lamp that generates heat, and the diffusion plate 30 is heat resistant.

A lower surface of the lower skin layer 32 has a wavy cross-section. The lower skin layer 32 modulates and mixes light. The lower skin layer 32 includes a plurality of ultraviolet proof particles 33 that blocks ultraviolet light. In the diffusion plate 30 in FIG. 6, a light having a wavelength of no more than about 360 nm is absorbed or reflected by the ultraviolet proof particles 33. The absorbed light generates excitons in the ultraviolet proof particles 33 so that visible light is generated from the ultraviolet proof particles 33.

The lower skin layer 32 has a greater refractive index than air to decrease the number of bright lines and shadow lines.

The core plate 34 is on the lower skin layer 32. The core plate 34 diffuses the light that passed through the lower skin layer 32 so that the light that passes through the core plate 34 is evenly incident on the upper skin layer 36. The core plate 34 may include a plurality of light scattering particles that scatter the light. In the diffusion plate 30 in FIG. 6, the core plate 34 has light transmittance of no more than about 70% and a haze value of about 90%.

The upper skin layer 36 has a prism patterned on a front surface thereof. The upper skin layer 36 is on the core plate 34. An interior angle of the patterned prism is about 55 degrees to about 88 degrees. In the diffusion plate 30 in FIG. 6, a pitch between adjacent prisms of the prism shape is about 150 μm, and a height of the prisms of the prism shape is about 50 μm. The prism extends in a longitudinal direction of a light source unit (not shown).

According to the diffusion plate 30 in FIG. 6, the diffusion plate 30 has a triple layered structure that has different functions from one another. In particular, the lower skin layer 32 modulates and mixes light path to decrease the appearance of bright lines and shadow lines. The core plate 34 increases a randomness of the light that has passed through the lower skin layer 32, thereby diffusing the light. The upper skin layer 36 guides the diffused light toward a viewer's side of the diffusion plate 30 to increase a luminance when viewed in a plan view of the diffusion plate 30.

In addition, the prism pattern prevents a deformation of the diffusion plate 30 due to moisture. Deformation or a distortion due to heat may also be prevented.

FIG. 7 is a cross-sectional view showing optical characteristics of the diffusion plate shown in FIG. 6. As shown, light enters the diffusion plate through the lower skin layer 32 and exits the diffusion plate through the upper skin layer 36. Refractive indexes of the lower and upper skin layers 32 and 36 are greater than that of the core plate 34. Light that is reflected from one of the core plate 34 and the lower and upper skin layers 32 and 36 is not shown in FIG. 7.

Referring to FIG. 7, when the light is incident on the lower skin layer 32, the light is refracted by the lower skin layer 32 so that the light that has passed through the lower skin layer 32 is incident on the core plate 34. The lower skin layer 32 has a greater refractive index than air so that the angle of refraction is smaller than the angle of incidence at the interface between the air and the lower skin layer 32.

The core plate 34 is on the lower skin layer 32. The core plate 34 diffuses the light that has passed through the lower skin layer 32 so that the light that passes through the core plate 34 is incident on the upper skin layer 36. The core plate 34 has a smaller refractive index than the lower skin layer 32 so that the angle of refraction is smaller than the angle of incidence at the interface between the lower skin layer 32 and the core plate 34.

The upper skin layer 36 is on the core plate 34. The light that is incident on the upper skin layer 36 is refracted by the upper skin layer 36 before exiting the upper skin layer 36. The upper skin layer 36 has a greater refractive index than the core plate 34 so that the angle of refraction is smaller than the angle of incidence at the interface between the core plate 34 and the upper skin layer 36. In addition, the angle of refraction is smaller than the angle of incidence at the interface between the upper skin layer 36 and air.

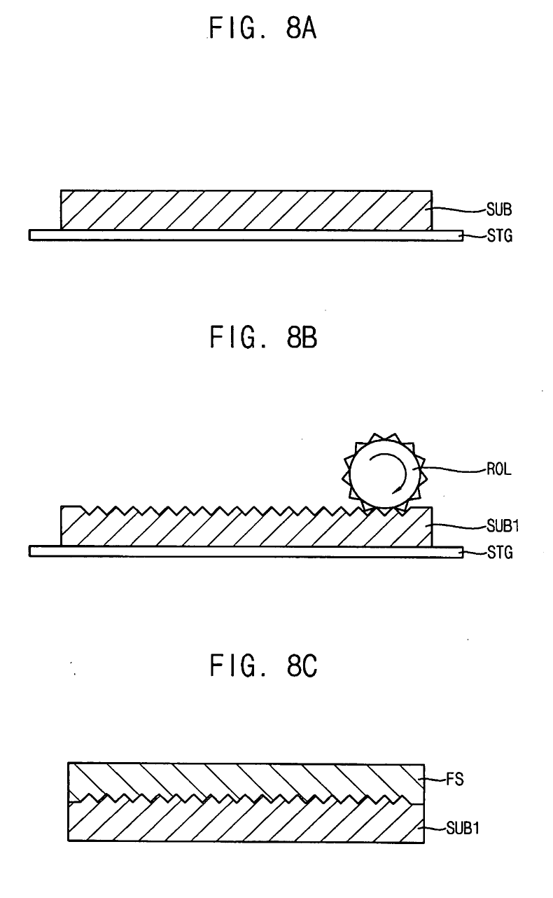

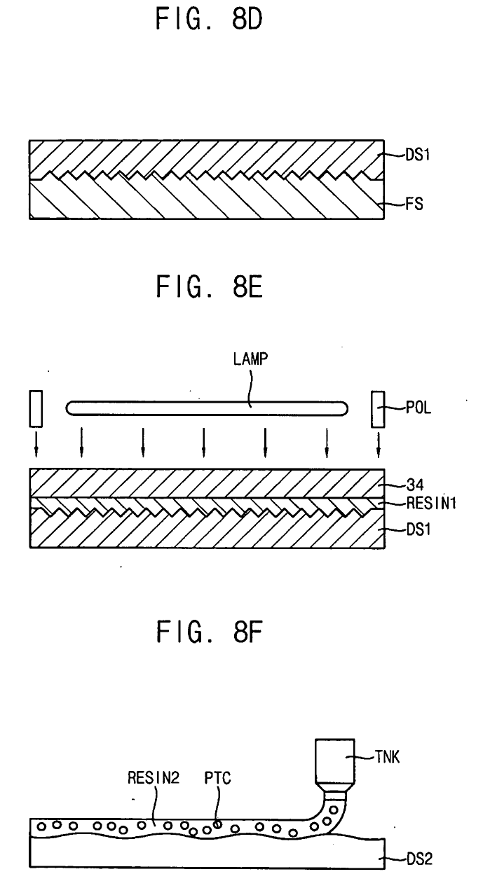

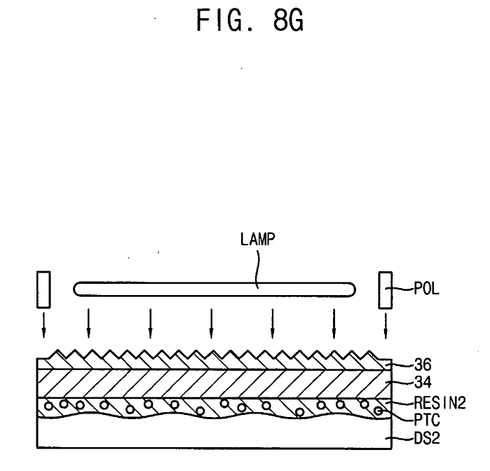

FIGS. 8A to 8G are cross-sectional views showing a method of manufacturing the diffusion plate shown in FIG. 6.

Referring to FIG. 8A, a base substrate SUB is prepared on a stage STG. A metal is deposited on the base substrate SUB to a thickness of about 1 mm. Examples of the metal that can be used for the deposition include copper, brass, aluminum, nickel, etc. A surface of the base substrate SUB is polished by a flat diamond polisher (not shown).

Referring to FIG. 8B, a plurality of recesses that have substantially the same depth is formed on the base substrate SUB using a roller ROL having a plurality of protrusions. Alternatively, the recesses may be formed using a diamond bite (not shown). An interior angle of each of the recesses is about 55 degrees to about 88 degrees. The pitch between adjacent recesses is about 150 μm.

Referring to FIG. 8C, a father stamper FS is formed by a casting process. In the casting process, a molten metal is on a base substrate SUB1 having the recesses, and then cooled to be solidified. Therefore, the father stamper FS has a pattern that is the reverse of the recesses of the base substrate SUB1.

Referring to FIG. 8D, a first daughter stamper DS1 is formed by a casting process using the father stamper FS. In the casting process for forming the first daughter stamper DS1, a molten metal is on the father stamper FS, and then cooled to be solidified. Therefore, the first daughter stamper DS1 has a pattern that is the reverse of the pattern on the surface of the father stamper FS, and the first daughter stamper DS1 has substantially the same cross-section as the base substrate SUB1. A plurality of daughter stampers such as a second daughter stamper, a third daughter stamper, etc., may also be formed through the casting process.

In FIG. 8D, the father stamper FS has substantially same cross-section as the diffusion plate 30, and the base substrate SUB has substantially same cross-section as the first daughter stamper DS1. That is, the pattern on the father stamper FS is a reverse of the pattern on the diffusion plate 30.

Referring to FIG. 8E, a first ultraviolet curable resin RESIN1 is coated on the recesses of the first daughter stamper DS1, and a core plate 34 is prepared on the first ultraviolet curable resin RESIN1. A peripheral region of the core plate 34 is pressed by a side compressor POL, and an ultraviolet light is irradiated onto the first ultraviolet curable resin RESIN1 so that the first ultraviolet curable resin RESIN1 is attached to the core plate 34. The first daughter stamper DS1 is then removed from the first ultraviolet curable resin RESIN1. Therefore, the upper skin layer 36 is completed.

Referring to FIG. 8F, a second ultraviolet curable resin RESIN2 that includes the ultraviolet proof particles PTC is coated on recesses of a second daughter stamper DS2. A tanker TNK supplies the recesses of the second daughter stamper DS2 with the second ultraviolet curable resin RESIN2.

Referring to FIG. 8G, the ultraviolet curable resin RESIN1 on the core plate 34 (see FIG. 8E) forms the upper skin layer 36. The core plate 34 is placed on the second ultraviolet curable resin RESIN2 so that the second ultraviolet curable resin RESIN2 and the first ultraviolet curable resin RESIN1 (which is now the upper skin layer 36) are on opposite surfaces of the core plate 34. A peripheral region of the core plate 34 is pressed by the side compressor POL, and ultraviolet light that is generated from a lamp LAMP is irradiated onto the second ultraviolet curable resin RESIN2 so that the second ultraviolet curable resin RESIN2 is attached to the core plate 34. The second daughter stamper DS2 is then removed from the second ultraviolet curable resin RESIN2. This concludes a formation of the lower skin layer 32.

The diffusion plate 30 includes the multi-layered structure that is a hybrid-structure. The diffusion plate 30 can be used for a backlight assembly of a flat panel display device. The flat panel display device includes an organic light emitting display (OLED) device, a liquid crystal display (LCD) device, a plasma display panel (PDP) device, etc.

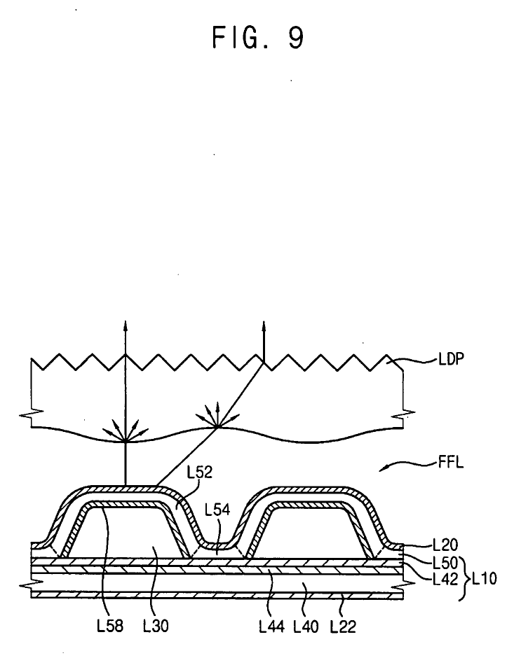

FIG. 9 is a cross-sectional view showing the path of a backlight assembly in accordance with an embodiment of the present invention. The backlight assembly includes a diffusion plate having a multi-layered structure.

Referring to FIG. 9, the flat fluorescent lamp FFL includes a lamp body L10 and a first external electrode L20. The lamp body L10 includes a plurality of discharge spaces L30 that are substantially parallel to one another when viewed from a plan view of the backlight assembly.

The first external electrode L20 is on an outer surface of the lamp body L10 corresponding to end portions of the discharge spaces L30 so that the first external electrode L20 crosses the discharge spaces L30.

The lamp body L10 includes a rear substrate L40 and a front substrate L50. The front substrate L50 is combined with the rear substrate L40 to form the discharge spaces L30. The rear substrate L40 has a quadrangular shape. In FIG. 9, the rear substrate L40 is a glass substrate that transmits a visible light and blocks ultraviolet light. The front substrate L50 may include substantially the same material as the rear substrate L40.

The front substrate L50 includes a plurality of discharge space portions L52, a plurality of space dividing portions L54 and a sealing portion (not shown). The discharge space portions L52 are spaced apart from the rear substrate L40 to form the discharge spaces L30. The space dividing portions L54 make contact with the rear substrate L40 between the discharge space portions L52. The sealing portion L56 corresponds to a peripheral region of the front substrate L50, and surrounds the discharge space portions L52 and the space dividing portions L54.

The space dividing portions L54 of the front substrate L50 are combined with the rear substrate L40 by a pressure difference between the discharge spaces L30 and outside of the flat fluorescent lamp FFL. In particular, the rear substrate L40 is combined with the front substrate L50, and the air that is between the rear and front substrates L40 and L50 is discharged so that the discharge spaces L30 are evacuated from the discharge spaces L30. A discharge gas is injected into the evacuated discharge spaces L30. In FIG. 9, a pressure of the discharge gas in the discharge spaces L30 is about 50 Torr to 70 Torr, and an atmospheric pressure outside of the flat fluorescent lamp FFL is about 760 Torr, thereby forming the pressure difference. Therefore, the space dividing portions L54 make contact with the rear substrate L40.

The lamp body L10 further includes a first fluorescent layer L42, a reflecting layer L44 and a second fluorescent layer L58. The reflecting layer L44 is on an upper surface of the rear substrate L40, and the first fluorescent layer L42 is on the reflecting layer L44. The second fluorescent layer L58 is on a lower surface of the front substrate L50. An ultraviolet light generated from a plasma discharge in the discharge spaces L30 is irradiated onto the first and second fluorescent layers L42 and L58 to generate excitons. The excitons generate the visible light. A portion of the visible light that is generated by the first and second fluorescent layers L42 and L58 is reflected from the reflecting layer L44 toward the front substrate L50 to prevent light leakage through the rear substrate L40.

The first external electrode L20 is on the upper surface of front substrate L50. In FIG. 9, two first external electrodes L20 are on the end portions of the front substrate L50 substantially perpendicular to a longitudinal direction of the discharge spaces L30. Each of the first external electrodes L20 crosses the discharge spaces L30.

Luminance is greater in the area adjacent to the discharge spaces L30 than in the area between adjacent discharge spaces L30. In FIG. 9, a thickness of the light diffusion plate LDP corresponding to the discharge spaces L30 is greater than a thickness of the diffusion plate LDP between the adjacent discharge spaces L30.

Referring again to FIG. 9, the thickness of the diffusion plate LDP may be varied based on the luminance of the flat fluorescent lamp FFL to decrease the appearance of bright lines and shadow lines on the diffusion plate LDP.

The backlight assembly includes the flat fluorescent lamp FFL. Alternatively, the backlight assembly may include a plurality of lamps to form a direct-illumination-type backlight assembly.

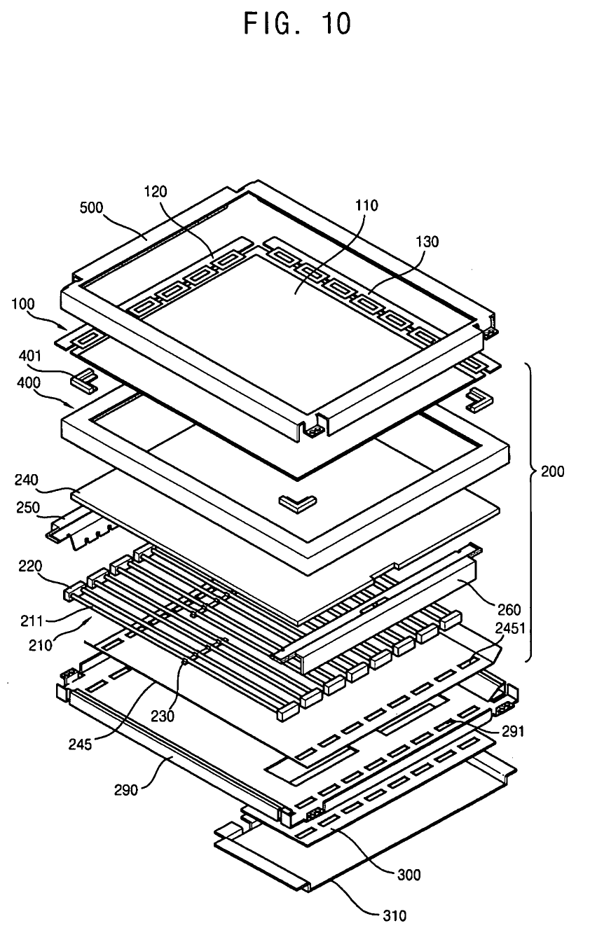

FIG. 10 is an exploded perspective view showing a display device in accordance with one embodiment of the present invention. The display device includes a backlight assembly of a direct-illumination-type. In other embodiments, the display device may include a backlight assembly of an edge-illumination type.

Referring to FIG. 10, the display device includes a display unit 100, a backlight assembly 200 and a receiving container 290. The backlight assembly 200 is under the display unit 100 to generate light. The display unit 100 displays an image using the light generated from the backlight assembly 200. The receiving container 290 receives the display unit 100 and the backlight assembly 200.

The display unit 100 includes a display panel 110, a gate printed circuit board (PCB) 120 and a data PCB 130. The display panel 110 displays the image. The gate PCB 120 applies a gate driving signal to the display panel 110. The data PCB 130 applies a data driving signal to the display panel 110. The display panel 110 includes a first substrate (not shown), a second substrate (not shown) and a liquid crystal layer (not shown). The second substrate (not shown) corresponds to the first substrate (not shown). The liquid crystal layer (not shown) is interposed between the first and second substrates (not shown).

The first substrate (not shown) includes a glass substrate and a plurality of thin film transistors (TFTs) that are arranged on the glass substrate in a matrix shape. A source electrode of each of the TFTs is electrically connected to a data line. A gate electrode of each of the TFTs is electrically connected to a gate line. A drain electrode of each of the TFTs is electrically connected to a pixel electrode that includes a transparent conductive material.

The second substrate (not shown) is a color filter substrate. The second substrate (not shown) includes a color filter having a thin film shape and a common electrode. The common electrode that includes a transparent conductive material is formed on the color filter. Examples of the transparent conductive material that can be used for the common electrode include indium tin oxide (ITO), amorphous ITO, indium zinc oxide (IZO), zinc oxide (ZO), etc.

When an electric power is applied to the gate electrode and the source electrode, the TFT is turned on to form an electric field between the pixel electrode and the common electrode. Liquid crystals in the liquid crystal layer vary their arrangement in response to the electric field applied thereto, thereby changing a light transmittance of the liquid crystal layer. Therefore, the image is displayed using the light that has passed through the liquid crystal layer.

The backlight assembly 200 includes a lamp unit 210, a lamp holder 220 and a diffusion plate 240. The lamp unit 210 includes a plurality of lamps 211 to generate the light. The lamp holder 220 fixes the lamps 211 to the receiving container 290. The diffusion plate 240 increases a light uniformity of the light generated from the lamp unit 210. The diffusion plate 240 increases the luminance when viewed in a plan view of the backlight assembly 200. The diffusion plate 240 of FIG. 10 is the same as in FIGS. 2 to 9. Thus, any further explanation concerning the above elements will be omitted.

In the display device of FIG. 10, the lamp unit 210 includes the lamps 211, and each of the lamps 211 has an extended rod shape. Alternatively, the lamp unit 210 may include a plurality of U-shaped lamps. The lamp unit 210 may include a cold cathode fluorescent lamp (CCFL), an external electrode fluorescent lamp (EEFL), a light emitting diode (LED), etc. The CCFL may have a lamp body and an internal electrode in the lamp body. The EEFL may have a lamp body and an external electrode on the lamp body.

The inverter 300 applies a driving signal to the lamp unit 210. In the display device in FIG. 10, the inverter 300 is a printed circuit board (PCB). The inverter cover 310 includes a metal to cover the inverter 300. Therefore, an electromagnetic field generated from the inverter 300 is blocked by the inverter cover 310 to prevent an electromagnetic interference (EMI).

The lamp holder 220 covers electrodes of the lamps 211. The lamp holder 220 is combined with the receiving container 290 to fix the lamps 211 to the receiving container 290. The reflecting sheet 245 and the receiving container 290 have a plurality of fixing holes 2451 and 291, respectively.

The reflecting sheet 245 is under the lamp unit 210 so that the light generated from the lamp unit 210 is reflected from the reflecting sheet 245 toward the display panel 110. The reflecting sheet 245 includes the fixing hole 2451 corresponding to the lamp holder 220.

The backlight assembly 200 further includes a lamp supporter 230. The lamp supporter 230 supports the lamps 211 so that the lamps 211 are spaced apart from one another by a constant distance. In addition, the lamp supporter 230 also supports the diffusion plate 240 so that the diffusion plate 240 is spaced apart from the receiving container 290 by a constant distance. The lamp supporter 230 is combined with the receiving container 290 through a combining hole formed on the reflecting sheet 245.

The backlight assembly 200 further includes a first side mold 250 and a second side mold 260. The first and second side molds 250 and 260 are combined with the receiving container 290 so that end portions of the lamp unit 210 are received in the receiving space of the receiving container 290.

The first and second side molds 250 and 260 support the diffusion plate 240. At least one of the first and second side molds 250 and 260 includes a diffusion plate fixing portion 252 and an optical sheet fixing portion 253.

Each of the first and second side molds 250 and 260 includes a plastic. In the display device in FIG. 10, each of the first and second side molds 250 and 260 includes a heat releasing plastic having a heat conductivity of no less than about 20 W/m·K. For example, the heat releasing plastic may be CoolPoly™ manufactured by CoolPolymer Co. in U.S.A. The CoolPoly is the heat releasing plastic having the heat conductivity of about 10 W/m·K to about 100 W/m·K. W, m and K represent watt, meter and Kelvin temperature, respectively.

The heat generated from the lamp unit 210 is radiated into the first and second side molds 250 and 260. The first and second side molds 250 and 260 transmit the heat to the receiving container 290.

The light generated from the lamp unit 210 passes through the diffusion plate 240.

The middle mold 400 is combined with the receiving container 290 to fix the diffusion plate 240 to the receiving container 290. The middle mold 400 supports the display panel 110. A panel guide member 401 is on the middle mold 400 to guide the display panel 110. In the display device in FIG. 10, the panel guide member 401 includes an elastic material. Examples of the elastic material include natural rubber, synthetic rubber, etc. Alternatively, the panel guide member 401 may be integrally formed with the middle mold 400. The panel guide member 401 is on the corners of the middle mold 400.

The receiving container 290 includes a bottom plate and a plurality of sidewalls that protrude from the sides of the bottom plate to form a receiving space. The display panel 110 and the backlight assembly 200 are received by the receiving space. The receiving container 290 includes a metal.

The top chassis 500 is combined with the receiving container 290 to fix the display unit 100 and the backlight assembly 200 to the receiving container 290.

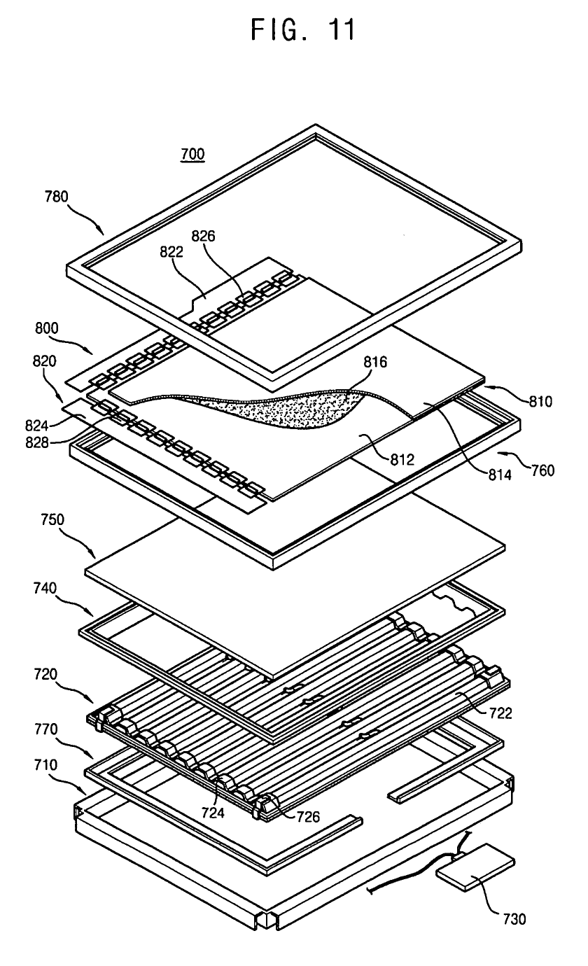

FIG. 11 is an exploded perspective view showing a display device in accordance with another embodiment of the present invention. The display device is an LCD device having a flat fluorescent lamp (FFL) that generates a light having a planar shape.

Referring to FIG. 11, the LCD device 700 includes a receiving container 710, a flat fluorescent lamp (FFL) 720, an inverter 730 and a display unit 800.

The receiving container 710 includes a receiving space to receive the FFL 720.

The FFL 720 includes a lamp body 722, an external electrode 724 and an auxiliary electrode 726. The lamp body 722 includes a plurality of discharge spaces. The external electrode 724 crosses the end portions of the discharge spaces. The auxiliary electrode 726 is combined with the lamp body 722 to be electrically connected to the external electrode 724.

In particular, the lamp body 722 has a quadrangular shape to generate light. When the inverter 730 applies a discharge voltage to the lamp body, a plasma discharge is formed in the discharge spaces to generate an ultraviolet light. The ultraviolet light is changed into a visible light by a fluorescent layer (not shown) so that the visible light exits the fluorescent layer (not shown). The lamp body includes an internal space that is divided into the discharge spaces. The lamp body 722 includes a rear substrate and a front substrate that is combined with the rear substrate to form the discharge spaces.

The inverter 730 outputs the discharge voltage to the FFL 720 to generate the light.

The display unit 800 includes an LCD panel 810 and a driving circuit member 820. The LCD panel 810 displays the image based on the light generated from the FFL 720. The driving circuit member 820 applies driving signals to the LCD panel 810.

The LCD panel 810 includes a first substrate 812, a second substrate 814 and a liquid crystal layer 816. The second substrate 814 corresponds to the first substrate 812. The liquid crystal layer 816 is interposed between the first and second substrates 812 and 814.

The first substrate 812 includes a glass substrate and a plurality of thin film transistors (TFTs) that are arranged on the glass substrate in a matrix shape. A source electrode of each of the TFTs is electrically connected to a data line. A gate electrode of each of the TFTs is electrically connected to a gate line. A drain electrode of each of the TFTs is electrically connected to a pixel electrode that includes a transparent conductive material.

The second substrate 814 is a color filter substrate. The second substrate 814 includes a color filter in the form of a thin film and a common electrode. The common electrode that includes a transparent conductive material is formed on the color filter.

When an electric power is applied to the gate electrode and the source electrode, the TFT is turned on to form an electric field between the pixel electrode and the common electrode. Liquid crystals in the liquid crystal layer between the first and second substrates 812 and 814 vary their arrangement in response to the electric field applied thereto, thereby changing the light transmittance of the liquid crystal layer and displaying, the desired image.

The driving circuit member 820 includes a data PCB 822, a gate PCB 824, a data flexible circuit film 826 and a gate flexible circuit film 828. The data PCB 822 applies a data driving signal to the LCD panel 810. The gate PCB 824 applies a gate driving signal to the LCD panel 810. The data PCB 822 is electrically connected to the LCD panel 810 through the data PCB 826. The gate PCB 824 is electrically connected to the LCD panel 810 through the gate flexible circuit film 828. Examples of each of the data and gate flexible printed circuit films 826 and 828 include a tape carrier package (TCP) and a chip on film (COF).

The data flexible circuit film 826 is backwardly bent so that the data PCB 822 is on a side surface or a rear surface of the receiving container 710. The gate flexible circuit film 828 is backwardly bent so that the gate PCB 824 is on the side surface or the rear surface of the receiving container 710. Alternatively, an auxiliary signal line is formed on the LCD panel 810 and the gate flexible circuit film 828 so that the gate PCB 824 may be omitted.

The LCD device 700 may further include a first mold 740 interposed between the FFL 720 and the diffusion plate 750. The first mold 740 is combined with the receiving container 710 to fix the FFL 720 to the receiving container 710. The first mold 740 fixes a peripheral portion of the FFL 720 to the receiving container 710 to cover the external electrode 724, and to support sides of the diffusion plate 750. In the display device in FIG. 11, the first mold 740 has a frame-shape. Alternatively, the first mold 740 may include two U-shaped pieces, two L-shaped pieces or four L-shaped pieces that can fit together to form the corners of the FFL 720.

When the FFL 720 does not have the auxiliary electrode 726, an electrode (not shown) may be integrally formed with the first mold 740 and function as the auxiliary electrode 726. The electrode (not shown) that functions as the auxiliary electrode 726 corresponds to the discharge spaces.

The LCD device 700 further includes the diffusion plate 750 and a second mold 760.

The diffusion plate 750 is on the FFL 720 to diffuse the light generated from the FFL 720 to increase a luminance uniformity. The diffusion plate 750 of FIG. 11 is same as in FIGS. 2 to 9. Thus, any further explanation concerning the diffusion plate 750 will not be repeated for the LCD device 700.

The diffusion plate 750 has a plate shape of a predetermined thickness. The diffusion plate 750 is spaced apart from the FFL 720 by a constant interval. The diffusion plate 750 includes a transparent material and a diffusing agent. For example, the transparent material may include polymethyl-methacrylate (PMMA).

The second mold 760 is interposed between the diffusion plate 750 and the LCD panel 810. The second mold 760 presses a peripheral region of the diffusion plate 750 to fix the diffusion plate 750 to the receiving container 710, and supports the LCD panel 810. In the display device in FIG. 11, the second mold 760 has a frame shape. Alternatively, the second mold 760 may include two U-shaped pieces, two L-shaped pieces or four L-shaped pieces that can fit together to form the corners of the LCD panel 810.

The LCD device 700 may further include a cushioning member 770 interposed between the FFL 720 and the receiving container 710 to support the FFL 720. The cushioning member 770 is adjacent to the sides of the FFL 720 so that the FFL 720 is spaced apart from the receiving container 710 by a constant distance, thereby electrically insulating the FFL 720 from the receiving container 710 that has a metal. The cushioning member 770 contains an insulating material and may be compressible or flexible. In some embodiments, the cushioning member 770 has elasticity. For example, the cushioning member 770 may contain silicone. In the display device in FIG. 11, the cushioning member 770 has two U-shaped pieces. Alternatively, the cushioning member 770 may have four linear pieces corresponding to four sides of the FFL 720. The cushioning member 770 may have four L-shaped pieces corresponding to four corners of the FFL 720. The cushioning member 770 may have a frame shape.

The LCD device 700 may further include a top chassis 780 to fix the display unit 800 to the second mold 760. The top chassis 780 is combined with the receiving container 710 to fix the sides of the LCD panel 810 to the second mold 760. The data flexible circuit film 826 is backwardly bent so that the data PCB 822 is fixed on the sidewalls or the bottom plate of the receiving container 710. The top chassis 780 may have a strong metal that is resistant to an impact.

According to the present invention, the diffusion plate of the multi-layered structure includes the lower skin layer that has the transparent material to guide the light, the core plate that has the diffusing agent to diffuse the light, and the upper skin layer that has the prism shape to increase the luminance when viewed from the plan view thereof. Therefore, the number of the optical sheets is decreased. In addition, the bright line and the shadow line are also decreased.

Although the embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. A diffusion plate comprising:
a lower skin layer that modulates and mixes light;
a core layer on the lower skin layer to diffuse the light that has passed through the lower skin layer; and
an upper skin layer on the core layer, the upper skin layer having a prism patterned on a surface of the upper skin layer that is farthest from the core layer.

2. The diffusion plate of claim 1, wherein an interior angle of the prism is about 55 degrees to about 88 degrees.

3. The diffusion plate of claim 1, wherein the prism includes a plurality of prisms, and wherein a pitch of adjacent prisms is about 150 μm.

4. The diffusion plate of claim 1, further comprising an ultraviolet proof coating layer under the lower skin layer to block an ultraviolet light.

5. The diffusion plate of claim 1, wherein the lower skin layer further comprises a plurality of ultraviolet proof particles that block an ultraviolet light.

6. The diffusion plate of claim 1, wherein the core layer has different light transmittance from the lower or upper skin layer.

7. The diffusion plate of claim 1, wherein each of the lower and upper skin layers comprises a transparent material.

8. The diffusion plate of claim 1, wherein a lower surface of the lower skin layer comprises a wavy cross-section.

9. The diffusion plate of claim 1, wherein the lower skin layer has a greater refractive index than air.

10. The diffusion plate of claim 1, wherein the lower skin layer comprises at least one material selected from the group consisting of polycarbonate based resin, polymethyl-methacrylate based resin and methacrylate-styrene copolymer.

11. The diffusion plate of claim 1, wherein the core layer comprises a plurality of light scattering particles that scatter the light.

12. The diffusion plate of claim 1, wherein a light transmittance of the core layer is no more than about 70%.

13. The diffusion plate of claim 1, wherein a haze value of the core layer is about 90%.

14. The diffusion plate of claim 1, wherein the upper skin layer comprises at least one material selected from the group consisting of polycarbonate based resin, polymethyl-methacrylate based resin, methacrylate-styrene copolymer and polyethylene-terephthalate.

15. A backlight assembly comprising:
a light source unit that generates light; and
a diffusion plate that has a multi-layered structure including layers of varying light transmittance properties to enhance luminance uniformity of the light.

16. The backlight assembly of claim 15, wherein the diffusion plate is heat resistant.

17. The backlight assembly of claim 15, wherein the diffusion plate comprises:
a lower skin layer that modulates and mixes the light generated from the light source unit, the lower skin layer being adjacent to the light source unit;
a core layer on the lower skin layer to diffuse the light that has passed through the lower skin layer; and
an upper skin layer on the core layer, the upper skin layer having a prism patterned on a surface of the upper skin layer that is farthest from the core layer.

18. The backlight assembly of claim 17, wherein a height of the prism is about 50 μm.

19. The backlight assembly of claim 17, wherein the prism extends in a longitudinal direction of the light source unit.

20. The backlight assembly of claim 17, wherein the diffusion plate further comprises an ultraviolet proof coating layer under the lower skin layer.

21. The backlight assembly of claim 20, wherein a thickness of the ultraviolet proof layer is about 50 μm.

22. The backlight assembly of claim 20, wherein a thickness of the diffusion plate is about 2 mm.

23. The backlight assembly of claim 15, wherein the light source unit comprises a flat fluorescent lamp that generates light having a planar shape, and a thickness of the diffusion plate corresponding to discharge spaces of the flat fluorescent lamp is greater than a thickness of the diffusion plate between adjacent discharge spaces.

24. The backlight assembly of claim 15, wherein the light source unit comprises a plurality of lamps that are substantially in parallel with one another, and a thickness of the diffusion plate corresponding to the lamps is greater than a thickness of the diffusion plate between adjacent lamps.

25. A display device comprising:
a light source unit that generates light; and
a backlight assembly including:
a display panel on the light source unit to display an image using the light generated from the light source; and
a luminance improving unit that has a multi-layered structure with layers of varying light transmittance properties to increase a luminance uniformity of the light, the luminance improving unit being interposed between the light source unit and the display panel.

26. The display device of claim 25, wherein the light source unit comprises a flat fluorescent lamp corresponding to the display panel.

27. The display device of claim 25, wherein the light source unit comprises a plurality of lamps that are substantially in parallel with one another and corresponding to the display panel.

28. The display device of claim 27, further comprising a reflecting plate under the lamps.

29. The display device of claim 27, wherein the luminance improving unit comprises:
a diffusion layer;
a light guiding layer under the diffusion layer to guide and mix the light generated from the light source unit; and
a brightness enhancement layer on the diffusion layer to increase a luminance when viewed from a plan view of the backlight assembly, the brightness enhancement layer having a prism patterned on a surface of the brightness enhancement layer.
